(19) United States
(12) Patent Application Publication
(10) Pub. No.: US 2002/0165860 A1
(43) Pub. Date: Nov. 7, 2002

(54) Selective retrieval metasearch engine

(75) Inventors: Eric Glover, West Windsor, NJ (US); Stephen R. Lawrence, New York, NY (US)

Correspondence Address: PHILIP J FEIG, NEC RESEARCH INSTITUTE INC, 4 INDEPENDENCE WAY, PRINCETON, NJ, 08540

(73) Assignee: NEC Research Insititute, Inc., Princeton, NJ (US)

(21) Appl. No.: 09/896,338

(22) Filed: Jun. 29, 2001

Related U.S. Application Data
(60) Provisional application No. 60/289,223, filed on May 7, 2001.

(51) Int. Cl. G06F 7/00

(52) U.S. Cl. 707/5

(57) ABSTRACT

A selective retrieval metasearch engine uses relevance estimation and confidence computation to select documents for which additional information is to be obtained. The additional information is used to update relevance estimation for the selected documents. A selective retrieval metasearch engine improves execution time, resource usage, throughput, and/or result quality.

### CROSS-REFERENCE TO RELATED APPLICATION

This application claims priority on U.S. Provisional Application Ser. No. 60/289,223 filed May 7, 2001. The contents of the provisional application is hereby incorporated herein by reference.

### FIELD OF INVENTION

The present invention relates to metasearch engines, and particularly to a metasearch engine that uses selective retrieval of additional information to improve execution time, resource usage, throughput, and/or result quality.

### BACKGROUND OF THE INVENTION

Web search engines such as AltaVista (http://www.altavista.com/) and Google (http://www.google.com/) index the text contained on web pages, and allow users to find information with keyword search. Web search engines are described, for example, in “The Anatomy of a Large-Scale Hypertextual Web Search Engine”, S. Brin and L. Page, Seventh International World Wide Web Conference, Brisbane, Australia, 1998. A metasearch engine operates as a layer above regular search engines, which may include general-purpose web search engines such as AltaVista, specialized web search engines such as ResearchIndex (http://researchindex.org/), local search engines such as an Intranet search engine, or other search engines or databases accessible to the metasearch engine. As used hereinafter, the term “search engine” will be understood to refer to any system that accepts a search query and returns one or more results or documents. A metasearch engine accepts a search query, sends the query (possibly transformed) to one or more regular search engines, and collects and processes the responses from the regular search engines in order to present a list of documents to the user. For more information on metasearch engines see, for example, “The MetaCrawler Architecture for Resource Aggregation on the Web”, E. Selberg and O. Etzioni, IEEE Expert, January-February, pp. 11-14, 1997.

Search engines and metasearch engines return a ranked list of documents to the user in response to a query. The documents are ranked by various measures referred to as relevance, usefulness, or value measures. Broadly speaking, the goal is to rank the documents that are most relevant or most useful for the user query highly. As used herein the term “relevance” will be understood to refer to any of the various measures that may be used to score and rank documents in a search engine or metasearch engine. Note that relevance may be based on a keyword query and/or other information. For example, relevance may be based on a keyword query and an information need category as in “Architecture of a Metasearch Engine That Supports User Information Needs”, E. Glover, S. Lawrence, W. Birmingham, C. L. Giles, Eighth International Conference on Information and Knowledge Management, CIKM 99, pp. 210-216, 1999.

### SUMMARY OF THE INVENTION

A selective retrieval metasearch engine predicts the relevance of documents returned by regular search engines based on the summary information provided by the search engine. Additionally, the selective retrieval metasearch engine estimates a confidence value for each relevance prediction. The confidence value is used to determine whether or not to obtain additional information about the document, such as link statistics or the current contents of the document. If additional information is obtained a new prediction for the relevance of the document is computed. A selective retrieval metasearch engine can improve execution time, resource usage, and throughput by requiring fewer retrieval requests compared to content-based metasearch engines, without removing all improvements to result quality when compared to traditional metasearch engines.

As used hereinafter, the terms “result” and “document” will be understood to refer to the material retrieved by a search engine.

Current metasearch engines fall into one of the following two types. Type A metasearch engines obtain results from search engines and fuse them solely based on local data such as the titles, summaries, and URLs returned by the search engines. Examples of Type A metasearch engines include MetaCrawler (as discussed in Selberg et al. supra) and SavvySearch (“Experience with Selecting Search Engines Using Metasearch”, D. Dreilinger and A. Howe, ACM Transactions on Information Systems, Volume 15, Number 3, pp. 195-222, 1997). Type B metasearch engines obtain results from search engines and then retrieve the current contents of the documents listed to provide extra information and to improve the ability of the search engines to judge the relevance of documents. Examples of Type B metasearch engines include Inquirus, as described in “Context and Page Analysis for Improved Web Search”, S. Lawrence and C. L. Giles, IEEE Internet Computing, Volume 2, Number 4, pp. 38-46, 1998, and an early version of Inquirus2, as described in Glover et al. supra. Type B metasearch engines are also known as content-based metasearch engines. A preferred metasearch engine is described in pending U.S. Pat. application Ser. No. 09/113,751, filed Jul. 10, 1998, entitled “Meta Search Engine”, which is incorporated herein by reference.

Unfortunately, both Type A and Type B metasearch engines have significant problems. Type A is faster, but has difficulty with the ability to predict the relevance of documents because of the limited information available. This means that the metasearch engine can have significant difficulty ranking the possibly very large number of results returned by the search engines. Since users often do not have time to explore more than the top few results returned, it is very important for a search engine to be able to rank the best results near the top of all returned results. In addition, there are interface limits and the risk of returning invalid links with Type A metasearch engines. Type B engines eliminate invalid links and can produce more accurate estimates of the relevance of documents because the engine has access to the current contents of the documents. However, these engines are much slower and significantly more resource intensive due to the requirement of retrieving the current contents of all documents returned by the search engines. This is a substantial limitation of Type B engines, because it can be expensive, difficult and/or time-consuming to retrieve documents. For example, each document retrieved may incur a cost for the bandwidth used, retrieving documents may introduce a significant delay, and the provider of a document may wish to minimize the number of documents retrieved.

The present invention concerns selective retrieval. Selective retrieval is a method that provides accuracy comparable to a Type B metasearch engine, but with the execution time, resource usage, and/or throughput comparable to that of a Type A metasearch engine. A selective retrieval metasearch engine can determine for each result if sufficient information is available to accurately predict relevance or other criteria. If sufficient information is available, additional information is not retrieved, and the document can be scored or ranked immediately.

A principal object of the present invention is therefore, the provision of a metasearch engine that provides improved performance in terms of execution time, resource usage, throughput, or result quality.

Another object of the present invention is the provision of a method of performing selective retrieval in a metasearch engine.

Further objects of the invention will be more clearly understood when the following description is read in conjunction with the accompanying drawings.

### BRIEF DESCRIPTION OF THE DRAWINGS

FIG. 1 is a schematic block diagram of a web search engine;

FIG. 2 is a schematic block diagram of a web metasearch engine;

FIG. 3 is a schematic block diagram of a dispatcher;

FIG. 4 is a schematic block diagram of a result processor;

FIG. 5 is a flow diagram of a prior art Type A metasearch engine;

FIG. 6 is a flow diagram of a prior art Type B metasearch engine;

FIG. 7 is a flow diagram of a preferred embodiment of a selective retrieval metasearch engine; and

FIG. 8 is a schematic block diagram of another preferred embodiment of a selective retrieval metasearch engine.

### DETAILED DESCRIPTION

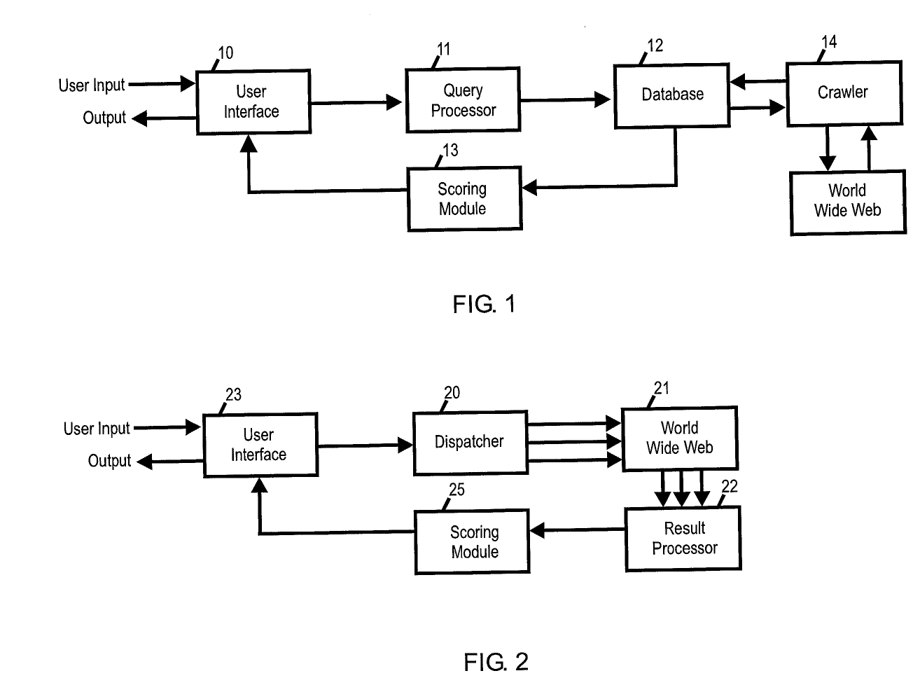

Referring now to the figures and to FIG. 1 in particular, there is shown a schematic block diagram of a web search engine. A web search engine performs the following steps: accept user input, process user input, apply database query, process results and display results.

User interface 10 accepts user input and presents the output. Presenting the output shall be understood to include, but not be limited to, returning results to a user, storing ranked results, or further processing ranked results. Query processor 11 generates a database query from the user input. Database 12 stores the knowledge about each result. Scoring module 13 processes each result before sending the result to the user interface 10 for display. In addition to these components, most web search engines have a crawler 14 which is used to populate and maintain their database.

The user interface defines what types of information a user can provide. The range of inputs is from a keyword query to a choice of options from a list or even tracking user actions. The goal of the input interface is to get as clear a description as possible of the user's information used.

The user interface also provides results to the user.

The query processor 11 converts the user input into a database query (a set of database queries) for use by the search engine. Users do not typically enter explicit database queries. Some query processors have the ability to generate database queries that are different from the query terms entered by the user, for example, stemming may be used in order to treat variants of the same word (e.g., plurals) as the same word. Some search engines interpret a user's query conceptually, identifying words of similar concepts as potentially useful, such as “car” and “automobile”. More advanced systems allow natural language queries.

The database 12 is the collective local knowledge about the documents on the web. A web search engine database determines what (local) documents can be returned to a searching user.

The scoring module 13 determines how documents are scored, and ultimately how they are ranked. An ordering policy refers to the method used by a search engine to produce a ranking of results.

Classical information retrieval systems use a scoring system based on the frequency of the query terms in each document relative to the number of documents in the database containing each term. Some modifications consider factors such as the location of the terms in the document; for example, terms in the title or top of the document may be given more weight than terms found elsewhere in the document.

Recently, the structure of the web has been used as a ranking factor. Since web page are interlinked, it is likely that pages that link to each other may be related. Similarly, pages that are linked to very frequently are likely to be more popular, or more authoritative.

The scoring module produces a score based on the available information about each result and the user's input. A scoring module that can score results independently of the other results has the property of independent scoring result. The primary factors in scoring besides text, appear to be link structure, page depth (how far down from the main page of a site), user supplied metadata, and page structure information (title, headings, font color, etc.)

A web crawler 14 is a tool that permits a search engine to locate web pages for inclusion in the database. Most general purpose search engines populate their database through the use of a crawler, also called a web robot. A crawler explores the web by downloading pages, extracting the URLs from each explored page, and adding the new URLs to its crawl list. A crawler must make decisions about which pages to examine, as well as which pages to index. Indexing is the process of adding a page to a search engine's database.

The simplest crawler can be thought of as a search algorithm. Beginning from a single page, p₀, download the page, extract the URLs {P₁, P₂, . . . , pₙ}, then download the new URLs and repeat. The specific ordering could be as simple as a breadth-first search, or possibly some form of best-first search.

The basic purpose of a crawler is to retrieve web pages for incorporation into the database. In addition to general-purpose search engines, there are special-purpose search engines. A special-purpose search engine is a search engine that covers only a specific area, such as research papers or news.

There are two basic types of crawlers, focused and general-purpose. Focused crawlers attempt to minimize the resources required to find web pages of a specific category.

FIG. 2 shows a schematic diagram of a metasearch engine. A metasearch engine is a search engine that searches other search engines. A metasearch engine takes user queries and submits them to multiple underlying search engines, and combines the results into a single interface. Metasearch engines are primarily used to improve coverage compared to a single search engine.

The architecture of a web metasearch engine is similar to the architecture of a regular web search engine. The primary difference is that the database of a web search engine is replaced by a virtual database comprising a dispatcher 20, other web search engines 21 (contained in the World Wide Web, WW) and a result processor 22. The other components of the metasearch engine are user interface 23, and scoring module 25.

A metasearch engine user interface 23 may have additional features related to decisions about where to search, but otherwise it is similar to a user interface 10 of a conventional search engine. A metasearch engine is limited by the performance of the search engines it queries. As a result, a metasearch engine may take significantly longer to complete a search than a single search engine, thereby affecting the design issues for the user interface.

The dispatcher 20 of a metasearch engine is similar to the query processor of a conventional search engine. A query processor generates database queries based on the input from the user interface, a dispatcher generates search engine requests from the user's input. The dispatcher must determine which search engines to query and how to query them.

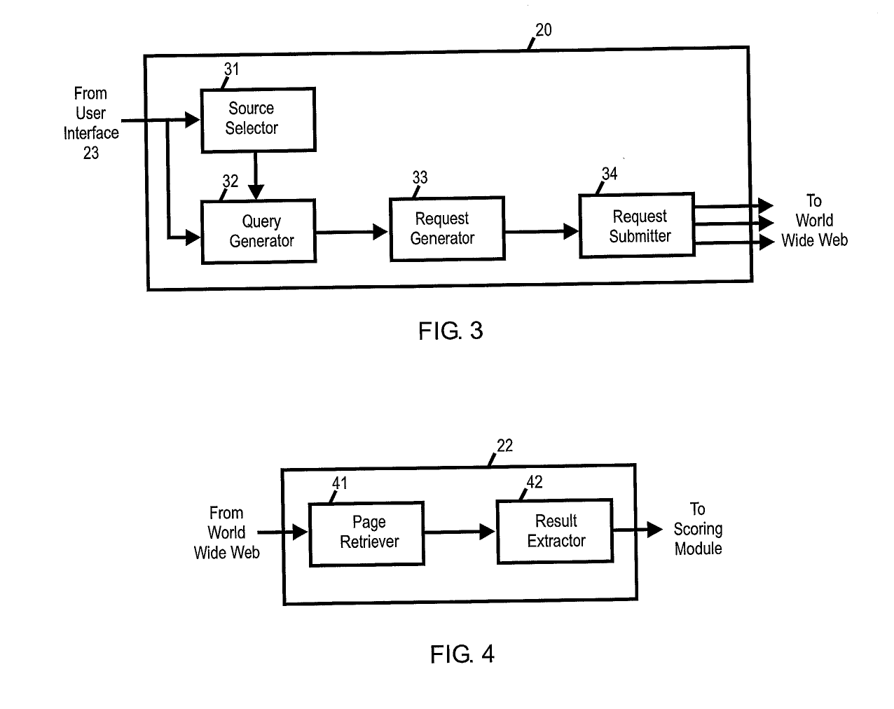

FIG. 3 is a schematic block diagram of a dispatcher 20. The dispatcher includes a source selector 31 to choose search engines to query and a query generator 32 to modify queries appropriately for each source. The queries are provided to a request generator 33 and then to a request submitter 34 for transmission to the World Wide Web.

The dispatcher makes the primary search decisions for a metasearch engine. The decisions of which search engines to query, and how to query each source, directly affect the ability of a metasearch engine to find useful results. A dispatcher also influences the resource requirements of a metasearch engine. The greater the number of search engines used the more network resources and greater time to complete a search.

FIG. 4 is a schematic block diagram of a result processor 22. The result processor of a metasearch engine acts like the output of a database in a regular search engine. Results sent from the result processor to the scoring module are similar to results returned from a database. The result processor accepts search engine responses and extracts from them the individual results.

A result processor 22 retrieves pages from the World Wide Web via page retriever 41 and extracts the results via result extractor 42.

The scoring module of a metasearch engine, like the scoring module of a regular search engine, defines the ordering policy of the search engine by scoring each result. If a metasearch engine cannot directly compare results, a fusion policy is used to combine the ranked lists of results into a single ordered list. A metasearch engine may have limited information for each result. The missing information may make it difficult to identify a result as useful for a given information need.

A metasearch engine has as its goal to return the best results or documents as judged by the user. However, a metasearch engine does not necessarily have a database, but rather relies on results from other search engines. A metasearch engine controls the set of results through the dispatcher; the set of results that can be returned is determined from the responses to the search engine requests generated through the dispatcher. A metasearch engine can choose the ranking of the documents it returns; however, it must often do so with limited information about each result.

A preference-based metasearch engine is a metasearch engine with explicit user preferences. Explicit preferences are used to improve the ability to find useful documents and improve performance. Three ways to utilize explicit user preferences in a preference-based metasearch engine are: improve the ability for a metasearch engine to locate useful documents; improve the ability for a metasearch engine to identify a document as useful; and improve performance by reducing search latency and lowering resource costs.

Having described search engines and metasearch engines in general, the present invention provides an improvement over conventional metasearch engines by providing selective retrieval metasearching.

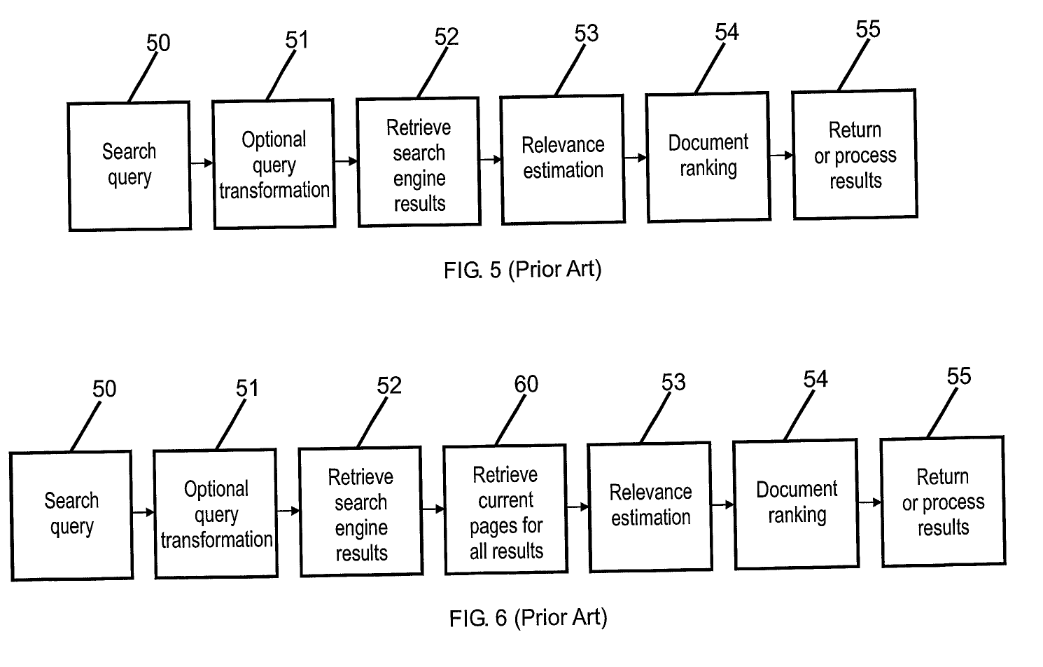

FIG. 5 shows a flow diagram of a Type A metasearch engine, comprising the following steps. A search query step 50 where a query is generated from a user input. An optional query transformation step 51, where the search query may be transformed in different ways for different search engines and there may be multiple transformed queries for a single search engine or database. A retrieve search engine results step 52 for sending queries to search engines or databases and retrieving the results from the search engines or databases in the form of URLs and optional summary information returned by the search engine or database such as a brief summary of the document, or the date of the document. Multiple queries may be sent to the same search engine, for example to request multiple result pages, or with different transformed queries. A relevance estimation step 53 where the relevance of the results returned by the search engines or databases is established. A document ranking step 54 for ranking the results based on the estimated relevance. A return or process results step 55 for returning the ranked results to the user.

In practice, a Type A metasearch engine sends a user-determined search query 10 to one or more search engines or databases. The results of the search query are retrieved from the search engine(s) or database(s) 52. Relevance estimation step 53 estimates the relevance of the retrieved results. The documents are ranked 54 in accordance with the relevance estimation. The ranked results are returned to the user.

In an alternative embodiment, a query transformation step 51, as described above, is performed on the search query before the query is sent to the search engine(s) or database(s) and the results are retrieved.

Referring now to FIG. 6, there is shown a flow diagram of a Type B metasearch engine. A Type B metasearch engine performs all of the steps (50, 51, 52, 53, 54 and 55) in a Type A metasearch engine and further includes a retrieve current pages for all results step 60 for retrieving the current contents of the documents returned by the search engines (step 52) before performing a relevance estimation 53 of the documents. Retrieval of the contents of the documents allows for a more accurate estimate of the relevance.

Selective retrieval provides accuracy comparable to Type B metasearch engines, with execution time, resource usage, and/or throughput comparable to Type A metasearch engines. Operation of the selective retrieval metasearch engine will now be described in terms of examples.

Consider, for example, a user that is looking for product reviews of DVD players and consider the following two documents:

Document #1:Title: Bobs site of lots of stuff, Search engine summary: Bob provides everything you ever wanted to know, URL: http://www.bobstuff.com/DVD_PLAYERS .html.

Document #2:Title: GreatReviews.com reviews DVD players, Search engine summary: The top 5 DVD players of 2000 are reviewed, and editor picks are provided, URL: http://www.greatreviews.com/dvd_players_review.html.

In this example, document #1 is most probably not about DVD player reviews, however it might be. It is possible that document #1 is a DVD player review page, however this cannot be determined from the summary provided by the search engine. A Type A metasearch engine would rank this document low, or use a rank based on the original search engine rank, regardless of the contents or type of the document. A Type B metasearch engine would retrieve the contents of the document, and should be able to discover whether or not the document is a review page, and rank the document appropriately. A selective retrieval metasearch engine would first follow the steps of a Type A metasearch engine and judge that it did not know whether document #1 is a DVD player review page and then retrieve the document itself like a Type B metasearch engine.

For document #2, a Type A metasearch engine would not retrieve the document and rank it as appropriate, because sufficient information is available. A Type B metasearch engine would retrieve the document and rank it appropriately. A selective retrieval metasearch engine typically would not retrieve the document and rank it appropriately. Thus, a selective retrieval metasearch engine would only download one of the two documents and provide accuracy comparable to a Type B metasearch engine which needs to download both documents, and exhibit superior accuracy to a Type A metasearch engine.

As a second example, consider a user searching for current events about an airline strike. A metasearch engine would search one or more news sites, and possibly general-purpose search engines. CNN and AltaVista may be searched, for example. Consider the following documents.

Document #1:From CNN: Title: “News about the Northwest airline strike”, URL: http://cnn.com/stories/nwa_str.html, Date: unknown.

Document #2:From AltaVista: Title:“Northwest Airline strike—breaking news”, URL:http://www.cnn.com/news/03-21-01/nwest.html.

Document #3:From CNN:Title:“Latest news regarding the Northwest strike”, URL: http://cnn.com/stories/asba.htm, Date: Mar. 21, 2001.

Document #4:From AltaVista: Title:“Northwest Airlines homepage”, http://www.nwa.com/. Date: unknown.

A Type A metasearch engine would not retrieve any of the documents, and would be unable to accurately judge the relevance of #1 or #4, because it is unclear from the title and summary provided whether or not the documents are topically relevant and are news articles. The dates of documents #1 and #4 are unknown. The date may be an important part of the relevance computation—for example a user may strongly prefer more recent news articles. A Type B metasearch engine would retrieve all of the documents, which would be very expensive in terms of execution time and resource usage. Additionally, news sites may not want to have many documents retrieved in quick succession. These sites may, in turn, block the metasearch engine. A selective retrieval metasearch engine would probably not retrieve documents #2 and #3, but would retrieve #1 and #4, because there is insufficient information to predict the relevance of these documents—assuming that the relevance is a function of the date of the document. However if document #1 provided a date, there would be sufficient information. Document #3 is not retrieved because enough information to accurately estimate relevance is provided. Document #2 has a date in the URL, which may be enough to choose not to retrieve the document.

To implement a selective retrieval metasearch engine, a 2-stage prediction system can be used. A Type A metasearch engine predicts the relevance of a document based on a function of the summary information provided by the search engine (the URL, title, document summary, and search engine rank). Note that some of the summary information may not be used.

R₁=f₁ (summary_information), where R₁ is the predicted relevance.

A Type B metasearch engine retrieves the current contents of all documents and computes the relevance of a document based on a function of the current contents of the document and the summary information provided by the search engine. Note that some or all of the summary information may not be used.

R₂ =f₂ (summary_information and document_contents) A two-stage selective retrieval metasearch engine has three estimation functions. For each document returned by the search engines, the following are computed:

R₁=f₁ (summary_information), where R₁ is the predicted relevance.

C₃=f₃ (summary_information), where C₃ is the predicted confidence in the estimation of R₁.

The predicted confidence C₃ provides an estimate of how accurate the predicted relevance of R₁ is. The selective retrieval metasearch engine uses C₃ to determine how to proceed with each document.

If C₃>x, where x is a threshold, then the selective retrieval metasearch engine assumes that R₁ is accurate and uses R₁ for further processing, otherwise the current contents of the document are retrieved and the search engine computes:

R₂=f₂ (summary_information and document_contents)

The threshold x can be adjusted to balance the false positive rate and the number of retrievals. Alternative embodiments may have additional stages. An example would be a metasearch engine that uses link statistics as part of the computation of relevance. The metasearch engine has to query an external source to obtain the link statistics. A three-stage selective retrieval metasearch engine may work as follows. For each document returned by the search engines, the following are computed (as before):

R₁=f₁ (summary_information), where R₁ is the predicted relevance.

C₃=f₃ (summary_information), where C₃ is the confidence in the estimation of R₁.

The value C₃ provides an estimate of how accurate the prediction of R₁ is. The selective retrieval metasearch engine uses C₃ to determine how to proceed with each document.

If C₃>x₁, where is a threshold, then the selective retrieval metasearch engine assumes that R₁ is accurate and uses R₁ for further processing, otherwise the link statistics for the document are requested from the external source and the following is computed:

R₄ =f₄ (summary_information and link_statistics), where R₄ is the predicted relevance.

C₅=f₅ (summary_information and link_statistics), where C₅ is the predicted confidence in the estimation of R₄.

If C₅>x₂, where x₂ is a threshold, then the selective retrieval metasearch engine assumes that R₄ is accurate and uses R₄ for further processing, otherwise the current contents of the document are retrieved and the engine computes:

R₆ =f₆ (summary_information and link_statistics and document contents)

Depending on the expense and effectiveness of retrieving the link statistics and the full document details (which may differ for different URLs), it may be preferable to reverse the order of the last two stages.

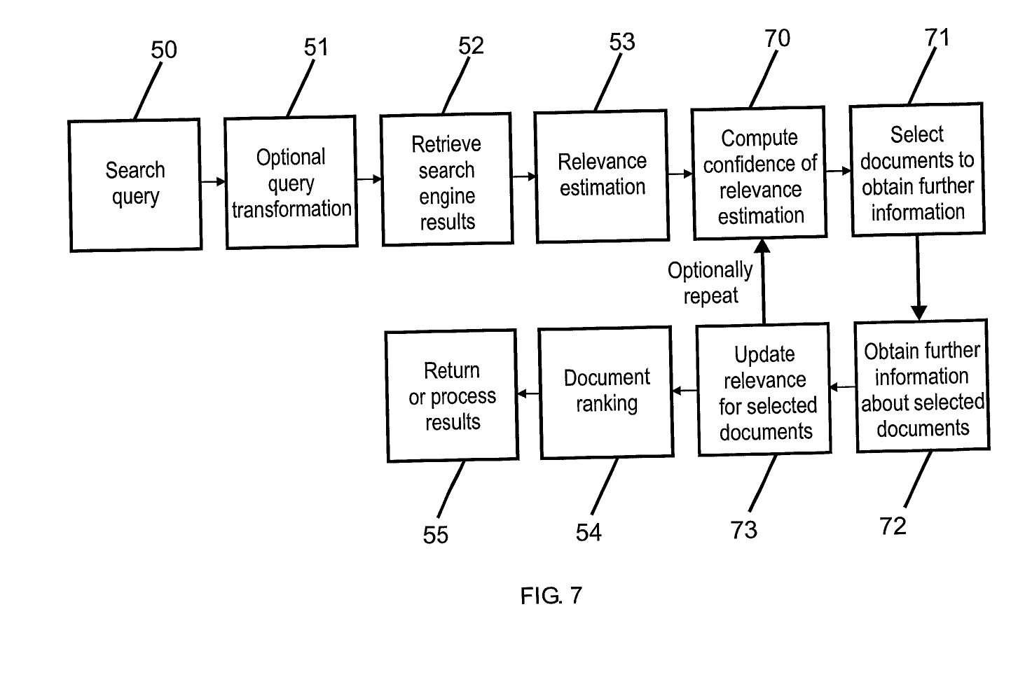

Referring now to FIG. 7, there is shown a flow diagram of a preferred embodiment of a selective retrieval metasearch engine. The selective retrieval metasearch engine comprises the steps 50, 51 (optional), 52, 53, 54 and 55 found in a Type A metasearch engine (FIG. 5) and further comprises a compute confidence of relevance estimation step 70 for computing the confidence of the relevance estimation after relevance estimation step 53. Note that in an alternative embodiment of the invention steps 53 and 70 may be combined. For example, a machine learning method such as neural networks or support vector machines may simultaneously compute relevance estimation and the confidence thereof. A select documents to obtain further information step 71 selects documents to obtain additional information when the computed confidence is below a threshold. An obtain further information about selected documents step 72 obtains additional information about documents for which further information is to be obtained. This may involve, for example, retrieving the current contents of documents or requesting statistics such as link statistics. An update relevance for selected documents step 73 updates the relevance estimation for selected documents using some or all of the additional information obtained by step 72. The selective retrieval metasearch engine may optionally repeat steps 70, 71, 72 and 73 one or more times. Note that some of the steps may be performed in parallel. For example, step 53 may be estimating the relevance of one or more results while step 52 is still sending queries 51 to and retrieving results 52 from search engines.

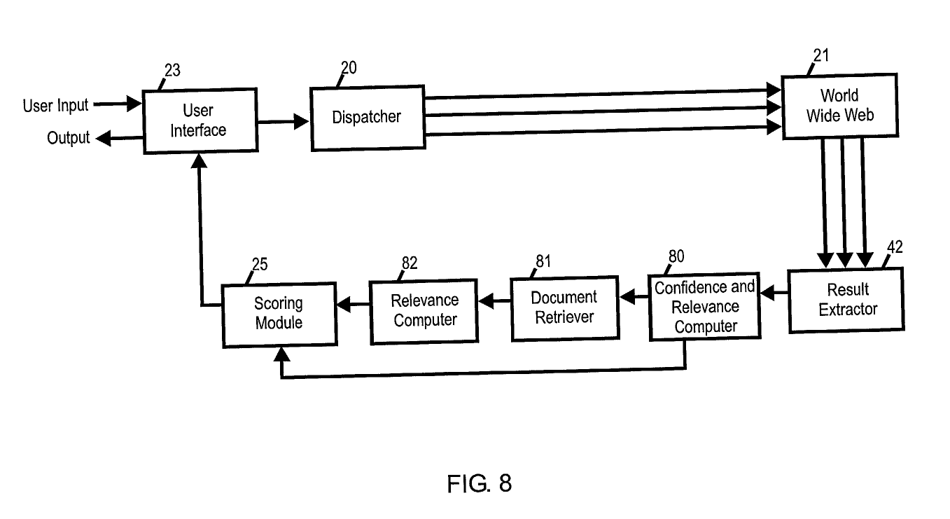

FIG. 8 is a schematic block diagram of a preferred embodiment of a selective retrieval metasearch engine. The elements 20, 21, 23 and 25 in the selective retrieval metasearch engine are the same as those shown in FIG. 2 and the element 42 is the same as that shown in FIG. 4. However, in the selective retrieval metasearch engine the output of the result extractor 42 is provided to the confidence and relevance computer 80 where the confidence of the relevance estimation is calculated. If the calculated confidence is equal to or greater than a predetermined threshold, the results are provided to scoring module 25. The contents of documents having a confidence below the predetermined threshold are retrieved by document retriever 81, and then provided to the relevance computer 82 where the relevance estimate of the retrieved document is recalculated based on the additional information from the newly retrieved document contents. The result is provided to the scoring module 25.

FIG. 8 represents a two-step selective retrieval metasearch engine. Alternatively, the revised relevance estimate from relevance computer 82 may be provided to a second confidence and relevance computer (not shown) where the confidence of the revised relevance may be calculated and the process is repeated based on the computed confidence and the retrieval of additional information if the confidence is below a second predetermined threshold.

The prediction or estimation of the relevance of documents may be done in several ways. For example, similarity measures such as TFIDF, or machine learning methods such as neural networks or support vector machines may be used.

The computation of the confidence of the relevance prediction may be done in several ways. For example, the amount and type of information returned by the search engine, similarity measures such as TFIDF, or machine learning methods such as neural networks or support vector machines may be used. If a classifier is used to classify the documents, the predicted class of the document and/or the accuracy of the classification, and/or other information may be used to compute the confidence.

Further alternative embodiments of the invention may dynamically alter the thresholds, for instance, based on system load or user preferences. For example, if the metasearch engine is under high load, then reducing the threshold(s) can reduce the number of retrievals for documents and further information, thereby increasing the number of queries that the metasearch engine can process in a given time. Similarly, users may wish to choose between two or more different thresholds. Lower thresholds can make the metasearch engine process a query faster, at the expense of possibly lower result quality. Users can tradeoff execution time and result quality. Further, the thresholds may depend on the relevance predictions. For example, it may be preferable to use a higher threshold when the predicted relevance is very low. Further still, the thresholds may be altered within a query, based on the current results. Still further alternative embodiments may use the number, magnitude, or distribution of relevance predictions for the documents that have already been processed in order to influence the decision to obtain additional information on future documents. That is, the thresholds may be a function of the relevance predictions for previous documents. For example, if many high quality documents have already been found, then it may be desirable to lower the threshold in order to minimize further execution time.

One of the advantages of a selective retrieval metasearch engine is that the overall processing time may be significantly shorter than that of a Type B metasearch engine. If a search system includes a dynamic interface, then each document may be displayed as soon as processing for the document has concluded. Documents for which it is not necessary to obtain all additional information can be shown to the user sooner than a Type B metasearch engine, further improving the speed at which results can be presented to the user. An alternative embodiment of the invention may immediately present results in a dynamic interface based on the initial relevance estimation, and dynamically update the relevance and ranking for documents where additional information is obtained. In this way, all documents returned by the search engines or databases may be immediately presented upon return from the search engine or database. As additional information is retrieved for selected documents, the relevance and ranking of these documents can be dynamically updated. This embodiment can match the speed of a Type A metasearch engine for displaying initial results, while very quickly improving results as additional information is obtained for selected documents.

In another alternative embodiment of the present invention, the retrieval of additional information for selected documents may continue until a particular stopping criterion is reached, for example the user cancels further processing or a maximum time limit is reached. The retrieval of additional information for selected documents may be ordered according to the predicted relevance and confidence for each document. For example, additional information for documents where the confidence in the relevance estimation is lower may be requested before additional information is requested for documents where the confidence in the relevance estimation is higher. When the

1. A selective retrieval metasearch engine comprising:
means for accepting a search query;
means for sending the search query to at least one search engine and for retrieving results of the search query from the at least one search engine;
means for estimating the relevance of each result retrieved;
means for computing a confidence of the relevance estimation for each result retrieved;
means for selecting results using the computed confidence of the relevance estimation;
means for obtaining additional information about the selected results;
means for updating the relevance estimation based on the additional information obtained for each selected result;
means for ranking the results retrieved based on the relevance estimation of each result retrieved; and
means for returning the ranked results.

2. A selective retrieval metasearch engine as set forth in claim 1, further comprising means for transforming the search query before sending the search query to at least one search engine.

3. A selective retrieval metasearch engine as set forth in claim 1, where the search query comprises at least one keyword.

4. A selective retrieval metasearch engine as set forth in claim 1, where the search query comprises additional information.

5. A selective retrieval metasearch engine as set forth in claim 1, where the search query comprises at least one keyword and additional information.

6. A selective retrieval metasearch engine as set forth in claim 1, where said means for obtaining additional information about the selected results includes retrieving the current contents of the selected results.

7. A selective retrieval metasearch engine as set forth in claim 1, where said means for obtaining additional information about the selected results includes obtaining information selected from the group consisting of link statistics, word statistics, and other document statistics.

8. A selective retrieval metasearch engine as set forth in claim 1, where said means for estimating the relevance of each result includes similarity measures means.

9. A selective retrieval metasearch engine as set forth in claim 1, where said means for estimating the relevance of each result includes machine learning means.

10. A selective retrieval metasearch engine as set forth in claim 9, where said means for estimating the relevance of each result includes a neural network.

11. A selective retrieval metasearch engine as set forth in claim 9, where said means for estimating the relevance of each result includes a support vector machine.

12. A selective retrieval metasearch engine as set forth in claim 1, where said means for computing a confidence includes using information provided by the at least one search engine.

13. A selective retrieval metasearch engine as set forth in claim 1, where said means for computing a confidence includes using similarity measures.

14. A selective retrieval metasearch engine as set forth in claim 1, where said means for computing a confidence includes using machine learning means.

15. A selective retrieval metasearch engine as set forth in claim 14, where said means for computing a confidence includes using a neural network

16. A selective retrieval metasearch engine as set forth in claim 14, where said means for computing a confidence includes using a support vector machine

17. A selective retrieval metasearch engine as set forth in claim 1, where said means for computing a confidence includes estimating an accuracy of classifying the result.

18. A selective retrieval metasearch engine as set forth in claim 1, where said means for selecting results includes means for comparing the confidence with a threshold.

19. A selective retrieval metasearch engine as set forth in claim 18, where said means for selecting results further comprises dynamically altering the threshold based on system load.

20. A selective retrieval metasearch engine as set forth in claim 18, where said means for selecting results further comprises dynamically altering the threshold based on user preference.

21. A selective retrieval metasearch engine as set forth in claim 18, where the threshold is based on the estimated relevance.

22. A selective retrieval metasearch engine as set forth in claim 18, where the threshold is based on relevance estimation for results that have already been estimated.

23. A selective retrieval metasearch engine as set forth in claim 1, where said means for returning results to the user presents initial results based on initial relevance estimations, and the relevance and rank of documents are updated as additional information about the selected results are obtained.

24. A selective retrieval metasearch engine as set forth in claim 23, where said means for obtaining additional information about the selected results obtains additional information from the selected results which is most expected to improve overall results of the metasearch engine.

25. A selective retrieval metasearch engine as set forth in claim 1, where said means for returning the ranked results comprises returning the ranked results to a user.

26. A selective retrieval metasearch engine as set forth in claim 1, where said means for returning the ranked results comprises storing the ranked results.

27. A selective retrieval metasearch engine as set forth in claim 1, where said means for returning the ranked results comprises further processing the ranked results.

28. A method of performing selective retrieval comprising the steps of:
accepting a search query;
sending the search query to at least one search engine and retrieving results of the search query from the at least one search engine;
estimating the relevance of each result retrieved;
computing a confidence of the relevance estimation for each result retrieved;
selecting results using the computed confidence of the relevance estimation;
obtaining additional information about the selected results;
updating the relevance estimation based on the additional information obtained for each selected result;
ranking the results retrieved based on the relevance estimation of each result retrieved; and
returning the ranked results.

29. A method of performing selective retrieval metasearch as set forth in claim 28, further comprising transforming the search query before sending the search query to at least one search engine.

30. A method of performing selective retrieval metasearch as set forth in claim 28, where the search query comprises at least one keyword.

31. A method of performing selective retrieval metasearch as set forth in claim 28, where the search query comprises additional information.

32. A method of performing selective retrieval metasearch as set forth in claim 28, where the search query comprises at least one keyword and additional information.

33. A method of performing selective retrieval metasearch as set forth in claim 27, where said obtaining additional information about the selected results includes retrieving the current contents of the selected results.

34. A method of performing selective retrieval metasearch as set forth in claim 28, where said obtaining additional information about the selected results includes obtaining information selected from the group consisting of link statistics, word statistics, and other document statistics.

35. A method of performing selective retrieval metasearch as set forth in claim 28, where said estimating the relevance of each result includes using similarity measures.

36. A method of performing selective retrieval metasearch as set forth in claim 28, where said estimating the relevance of each result includes using machine learning.

37. A method of performing selective retrieval metasearch as set forth in claim 36, where said estimating the relevance of each result includes using a neural network.

38. A method of performing selective retrieval metasearch as set forth in claim 36, where said estimating the relevance of each result includes using a support vector machine.

39. A method of performing selective retrieval metasearch as set forth in claim 28, where said computing a confidence includes using information provided by the at least one search engine.

40. A method of performing selective retrieval metasearch as set forth in claim 28, where said computing a confidence includes using information provided by similarity measures.

41. A method of performing selective retrieval metasearch as set forth in claim 28, where said computing a confidence includes using machine learning means.

42. A method of performing selective retrieval metasearch as set forth in claim 41, where said computing a confidence includes using a neural network.

43. A method of performing selective retrieval metasearch as set forth in claim 41, where said computing a confidence includes using a support vector machine.

44. A method of performing selective retrieval metasearch as set forth in claim 28, where said computing a confidence includes estimating an accuracy of classifying the result.

45. A method of performing selective retrieval metasearch as set forth in claim 28, where said selecting results includes comparing the confidence with a threshold.

46. A method of performing selective retrieval metasearch as set forth in claim 43, where said selecting results further comprises dynamically altering the threshold based on system load.

47. A method of performing selective retrieval metasearch as set forth in claim 43, where said selecting results further comprises dynamically altering the threshold based on user preference.

48. A method of performing selective retrieval metasearch as set forth in claim 43, where the threshold is based on the estimated relevance.

49. A method of performing selective retrieval metasearch as set forth in claim 43, where the threshold is based on relevance estimation for results that have already been estimated.

50. A method of performing selective retrieval metasearch as set forth in claim 28, where said returning results to the user presents initial results based on initial relevance estimations, and the relevance and rank of documents are updated as additional information about the selected results are obtained.

51. A method of performing selective retrieval metasearch as set forth in claim 50, where said obtaining additional information about the selected results obtains additional information from the selected results which is most expected to improve overall results of the metasearch engine.

52. A method of performing selective retrieval metasearch as set forth in claim 28, where said returning the ranked results comprises storing the ranked results.

53. A method of performing selective retrieval metasearch as set forth in claim 28, where said returning the ranked results comprises further processing the ranked results.

54. A method of performing selective retrieval metasearch as set forth in claim 28, where said means for returning the ranked results comprises returning the ranked result to a user.

55. A method of performing selective retrieval metasearch as set forth in claim 28, where said computing a confidence, said selecting results, said obtaining additional information, and said updating the relevance estimation are repeated a plurality of times.
